(19) United States
(12) Patent Application Publication
(10) Pub. No.: US 2004/0031656 A1
(43) Pub. Date: Feb. 19, 2004

(54) Electromotive clutch disc

(76) Inventor: Erick Maennle, Oberkirch (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/239,509

(22) PCT Filed: Jan. 26, 2001
(86) PCT No.: PCT/DE01/00313

(30) Foreign Application Priority Data
Mar. 22, 2000 (DE) 100142257

(51) Int. Cl. B60K 41/22

(52) U.S. Cl. 192/3.51

(57) ABSTRACT

In an electromotive clutch actuator for actuating a clutch between a drive motor and a transmission of a motor vehicle, which has a clutch rod for disengaging the clutch, an electric motor that actuates the clutch rod (15) by means of a self locking worm gear pair (14), and a housing (10) that contains at least the worm gear pair (14), in order to increase the self locking of the worm gear pair (14), a friction device (21) that generates a frictional moment is integrated into the worm gear pair (14) (FIG. 2).

### PRIOR ART

The invention is based on an electromotive clutch actuator for actuating a clutch between a drive motor and a transmission of a motor vehicle, as generically defined by the preamble to claim 1.

Electromotive clutch actuators of this kind, which are known, for example from DE 197 29 096 A1 or DE 44 33 836 C2, are increasingly used in motor vehicles in order to increase comfort, both in stand-alone applications such as in electromotive clutch management and as essential components of an automated shift transmission in which the clutch pedal is eliminated.

In order to be able, in addition to the comfort increase achieved by eliminating the clutch pedal, to further increase driving comfort through an improved damping of the drive train, the clutch actuator is operated using “moment tracking” operation when the clutch is engaged. In this type of operation, the clutch actuator is controlled so that the clutch can transmit slightly more torque than the torque currently output by the internal combustion engine. This has the advantage that all load impacts in the drive train cause the prestressed clutch to race temporarily and the ideal friction damper of the clutch converts the impact energy into heat. This considerably reduces oscillations of the drive train, which results in a considerable increase in comfort. Another advantage is the reduction of the switching times due to the significantly shorter paths in disengaging the clutch.

In order to be able to use small electric motors in the clutch actuator, self locking worm gear pairs are used in the clutch actuator so that when holding the disengaged clutch, the clutch actuator can be operated without current in a preset controller hysteresis. One problem in designs of this kind lies in the fact that worm gear pairs with self locking must in principle have an efficiency of >50%. In self locking transmissions, in addition to the low efficiency, the wear on the gearing is also critical. In addition, the worm gear pair is only self locking when the gearing is actually engaged. If the gearing is disengaged, even for only a short time due to the excitation of external oscillations, then there is no self locking in this operating state. In these cases, the clutch actuator experiences accelerations that are critical.

### ADVANTAGES OF THE INVENTION

The electromotive clutch actuator according to the invention has the advantage that by means of the additional frictional moment generated by the friction device, an additional self locking of the clutch actuator is achieved in the operation without current, and this additional self locking on the one hand permits the use of a small, compact electric motor for triggering the clutch and prevents jerking of the clutch due to readjustment of the controller during static or quasi-static operation, and on the other hand, permits the clutch to be operated using moment tracking operation. Through the self locking, the position controller can be embodied with a controller hysteresis. As long as the clutch actuator is within the controller hysteresis, the electric motor can be switched so that it is without current. Because of the overall greater self locking due to the additional frictional moment, the permissible actuation force of the clutch can be increased. Since the actuation force of the clutch with the predetermined clutch diameter is a function of the maximal torques of the internal combustion engine, greater torques of the internal combustion engine are permitted in the clutch. This is increasingly important in order to operate modern engines with torques that are increasing constantly due to gasoline or diesel direction injection.

Advantageous modifications and improvements of the electromotive clutch actuator disclosed in claim 1 are possible through the measures taken in the dependent claims.

According to one advantageous embodiment of the invention, the friction device is designed so that the frictional moment acts on the worm gear of the worm gear pair. To this end, the friction device has engaging means, which are disposed spaced radially apart from the axle supporting the rotating worm gear and which generate a frictional force between the worm gear and the housing. These means have at least one friction surface, which is disposed between the end face of the worm gear and a housing wall parallel to it, and have a spring that prestresses the worm gear axially against the housing wall.

### DRAWINGS

An invention will be explained in detail in the description below, in conjunction with an exemplary embodiment shown in the drawings.

FIG. 1 shows a view of an electromotive clutch actuator, in a depiction that is largely broken open,

FIG. 2 shows a section along the line II-II in FIG. 1,

FIG. 3 shows a top view a spring washer in the clutch actuator according to FIG. 2,

FIG. 4 shows a side view of the spring washer in FIG. 3,

FIG. 5 shows a section along the line V-V in FIG. 3.

### DESCRIPTION OF THE EXEMPLARY EMBODIMENT

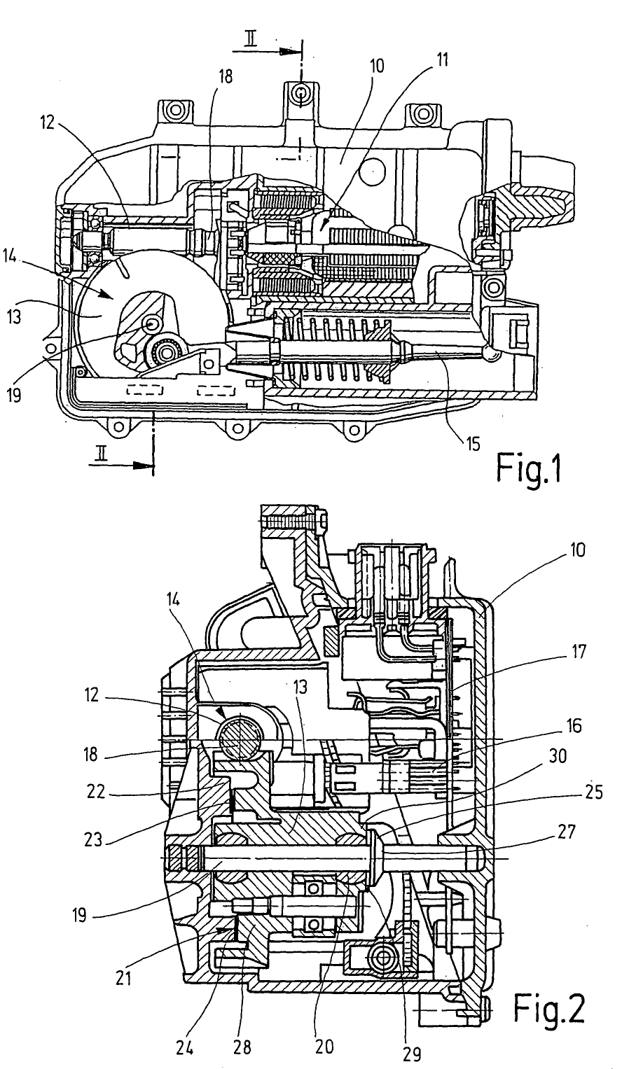

The electromotive clutch actuator shown from the side in a partially longitudinal section in FIG. 1 has a housing 10, which contains an electric motor 11, a worm gear pair 14 comprised of a worm 12 and worm gear 13, and a clutch rod 15 that is actuated by means of the worm gear pair 14 and disengages a clutch that is not shown here between the drive motor or the internal combustion engine of a motor vehicle and a transmission, counter to the force of a clutch spring. By means of a set of control electronics 16, which are accommodated on a printed circuit board 17 in the housing 10, the electric motor 11 is switched so that it is without current while the clutch is held in the disengaged position. The worm 12 of the self locking worm gear pair 14 is non-rotatably supported on the rotor shaft 18 of the electric motor 11, while the worm gear 13 is supported—in rotary fashion by means of two slide bearings 20—on an axle 19 affixed in the housing 10. The control electronics 16 also control the electric motor 11 so that the coupling moment that can currently be transmitted by the clutch is adapted to the current motor moment and is always a defined amount greater than the current motor moment. In such an operation, it is important that a reliable self locking of the clutch actuator is assured when the clutch is disengaged during operation of the electric motor 11 without current. This is assured by means of a friction device 21, which is integrated into the worm gear pair 14 and produces an additional frictional moment. The friction device 21 is disposed so that the frictional moment acts on the worm gear 13 of the worm gear pair 14, which is why the friction device 21, spaced radially apart to from the axle 19, has engaging means for generating a frictional force that acts between the worm gear 13 and the housing 10.

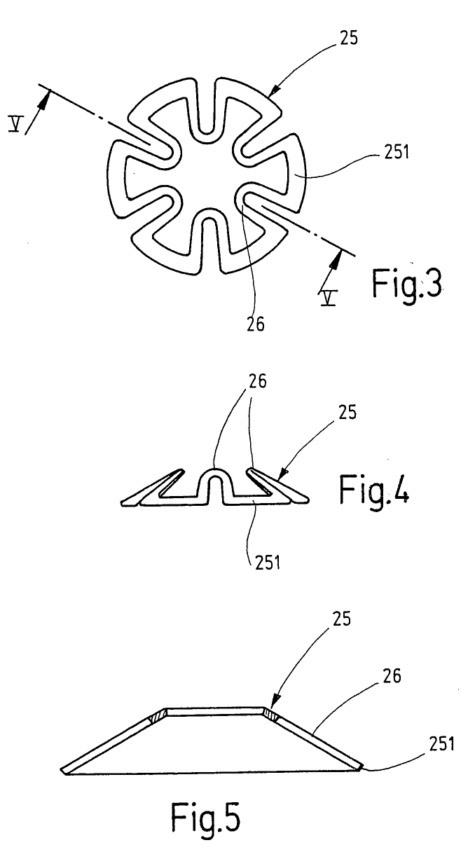

In particular, the friction device 21 has a friction surface 23 disposed between the end face of the worm gear 13 and a housing wall 22 parallel to it; for example, this friction surface is produced by disposing a friction lining concentric to the axle 19, on the housing wall 22, on the end face of the worm gear 13, or both of them. In the exemplary embodiment shown in FIG. 2, the friction surface 23 is disposed on an annular friction disk 24, preferably on both of its annular surfaces facing away from each other, which is disposed concentric to the axle 19 between the end face of the worm gear 13 and the housing wall 22. The required axial pressure of the worm gear 13 against the housing wall 22 by means of the friction disk 24 is exerted by an axially prestressed spring. The spring, which is embodied as a spring washer 25, is supported on one side against the end face of the worm gear 13 oriented away from friction disk 24 and is supported on the other side on the axle 19 that supports the worm gear. The spring washer 25 is shown in a top view in FIG. 3, a side view in FIG. 4, and a sectional view in FIG. 5. The spring washer 25 encompasses the axle 19 with inward protruding U-shaped fingers 26 and is supported there axially, e.g. by means of a snap ring or a lock washer inserted into a groove in the shaft. With an outer annular collar, which is comprised of annular segments 251 that join the fingers 26 to one another, the spring washer 25 rests against the end face of the worm gear 13 oriented away from friction disk 24. The geometric embodiment of the spring washer 25 described above and depicted in FIGS. 3 to 5 gives the spring a degressive characteristic curve so that independent of the installation dimensions, there is a constant spring tension, which remains unchanged over the service life despite wear on the friction disk 24. The initial spring stress of the spring washer 25 is chosen to be great enough that it prevents the worm gear 13 from lifting up from the friction disk 24 or the housing wall 22 in all operating conditions so that the frictional moment of the friction disk 24 is maintained even when there are powerful vibrations excited by the internal combustion engine when the clutch actuator is installed directly on the transmission. Otherwise, the friction disk 24 is structurally disposed so that the axial reaction force component of the worm gear pair 14 increases the prestressing force of the spring washer 25 when the clutch is disengaged and therefore when pressing against the clutch spring.

In order to obtain constant friction conditions, the end face of the worm gear 13 oriented toward the friction disk 24 has an axially protruding annular section 28 formed onto it, whose annular surface is congruent with the annular surface of the friction disk 24 and presses the friction disk 24 against the housing wall 22. This provides a constant friction radius so that the friction moment remains constant and aside from the initial spring stress of the spring, is determined only by the frictional coefficients between the friction disk 24 and the worm gear 13 on the one hand and the housing wall 22 on the other. If instead of the friction disk 24, a friction lining is used, which is attached to the housing wall 22 and/or the end face of the worm gear 13, then this friction lining is disposed congruent with the annular surface of the annular section 28.

If necessary, the additional frictional moment exerted in the worm gear pair 14 by the friction device 21 can be increased even further by the fact that the support of the spring washer 25 on the end face of the worm gear 13 oriented away from the friction disk 24 is provided by an additional friction disk 29. The outer collar of the spring washer 25 presses against the additional friction disk 29 and presses it against an annular axial projection 30 embodied coaxial to the axle 19. The friction disk 29 is non-rotatably connected to the spring washer 25 or can be alternatively affixed to the housing 10.

1. An electromotive clutch actuator for actuating a clutch between a drive motor and a transmission of a motor vehicle, with a clutch rod (15) for disengaging the clutch, an electric motor (11) that actuates the clutch rod (15) by means of a self locking worm gear pair (14), and a housing (10) that contains at least the worm gear pair (14), characterized in that a friction device (21) that generates a frictional moment is integrated into the worm gear pair (14).

2. The electromotive clutch actuator according to claim 1, characterized in that the worm gear pair (14) has a worm (12), which is supported on the rotor shaft (18) of the electric motor (11), and a worm gear (13), which is rotatably supported on an axle (19) affixed in the housing (10), and that the friction device (21) is embodied so that the frictional moment acts on the worm gear (13).

3. The electromotive clutch actuator according to claim 2, characterized in that the friction device (21) has engaging means, which are disposed spaced radially apart from the axle (19) and which are for generating a frictional force that acts between the worm gear (13) and the housing (10).

4. The electromotive clutch actuator according to claim 3, characterized in that the means have at least one friction surface (23), which is disposed between the end face of the worm gear (13) and a housing wall (22) that is parallel to it, and a spring (25) that prestresses the worm gear (13) axially against the housing wall (22).

5. The electromotive clutch actuator according to claim 4, characterized in that the at least one friction surface (23) is constituted by a friction lining, which is concentric to the axle (19) and is disposed on the end face of the worm gear (13) and/or on the housing wall (22).

6. The electromotive clutch actuator according to claim 4, characterized in that the at least one friction surface (23) is disposed on a friction disk (24), which is disposed concentric to the axle (19), between the end face of the worm gear (13) and the housing wall (22).

7. The electromotive clutch actuator according to claim 5 or 6, characterized in that the end face of the worm gear (13) and/or the housing wall (22) has an axially protruding annular section (28) formed onto it, whose annular surface supports the friction lining or presses against the friction disk (24).

8. The electromotive clutch actuator according to one of claims 4 to 7, characterized in that the spring is embodied as a conically precurved spring washer (25) that has flexible fingers (26), which are spaced apart from each other and constitute the generated surface of the cone, and is supported against the end face of the worm gear (13) oriented away from the friction surface (26) by means of annular segments (251), which connect the flexible fingers (26) to each other at the bases of the fingers on the outside, and is supported by means of the flexible fingers (26) on the axle (19) that supports the worm gear (13).

9. The electromotive clutch actuator according to claim 8, characterized in that the spring washer (25) has a degressive spring characteristic curve.

10. The electromotive clutch actuator according to claim 8 or 9, characterized in that the initial spring stress of the spring washer (25) is set so that the worm gear (13) is prevented from lifting up from the housing wall (22) in all operating states.

11. The electromotive clutch actuator according to one of claims 4 to 10, characterized in that the friction surface (23) is disposed so that when the clutch is disengaged, the axial reaction force of the worm gear pair (14) increases the prestressing force of the spring (25) that presses the worm gear (13) against the housing wall (22).

12. The electromotive clutch actuator according to one of claims 8 to 11, characterized in that the spring (25) is supported against the end face of the worm gear (13) oriented away from the friction surface (23) by means of an additional friction disk (29), which is non-rotatably attached to the spring (25) or the housing (10).

13. The electromotive clutch actuator according to claim 12, characterized in that the additional friction disk (29) is embodied in an annular form, with a defined ring width, and that the end face of the worm gear (13) oriented toward the spring washer (25) has an annular axial projection (30) embodied on it, against which the additional friction disk (29) is pressed.
